(19) United States
(12) Patent Application Publication
(10) Pub. No.: US 2009/0310805 A1
(43) Pub. Date: Dec. 17, 2009

(54) HEARING AID WITH ANTI-OCCLUSION EFFECT TECHNIQUES AND ULTRA-LOW FREQUENCY RESPONSE

(76) Inventor: Michael Petroff, Sierra Madre, CA (US)

Correspondence Address: TUTUNJIAN + BITETTO, P.C., 20 CROSSWAYS PARK NORTH, SUITE 210, WOODBURY, NY, 11797, US

(21) Appl. No.: 12/483,830

(22) Filed: Jun. 12, 2009

Related U.S. Application Data
(60) Provisional application No. 61/132,135, filed on Jun. 14, 2008.

(51) Int. Cl. H04R 25/00

(52) U.S. Cl. 381/318; 381/328; 381/313

(57) ABSTRACT

An occluding hearing aid having anti-occlusion effect techniques combined with at least one improvement which, in the preferred embodiment, includes enhancement of acoustic output in the lower-midrange and bass frequency regions, typically between substantially 40 and 500 Hz, which regions are crucial for natural reproduction of multimedia sound and music but are not optimally processed, and generally not provided at all, in prior art hearing aids in order to avoid exacerbation of the occlusion effect. In specific embodiments, the hearing aid of the present invention includes primary or first microphone exposed to external sound plus a secondary or second microphone exposed to sound within an ear canal, in which a signal produced by the secondary microphone is applied as negative feedback to an input of a non-gain controlling signal process and amplifier driving a hearing aid receiver (transducer), whereby, it has been determined by the present inventor, the occlusion effect may be substantially canceled. The hearing aid further comprises at least one of ten combinational improvements each providing substantial performance benefits over known techniques and devices.

### CROSS REFERENCE TO RELATED APPLICATIONS

This application claims priority from U.S. Provisional Patent application Ser. No. 61/132,135 filed on Jun. 14, 2008.

### BACKGROUND

1. Field of the Invention

The present invention relates to hearing aids, and more specifically to hearing aids with anti-occlusion effect techniques and ultra-low frequency response.

2. Discussion of Related Art

Distinctly opposing approaches have been employed in the field of audiology versus the field of audio in terms of processing multimedia sound, particularly when such sound predominantly comprises music. Prior art audiometric signal processes provide extremely limited low frequency response in order to minimize the occlusion effect in hearing aids and/or improve speech intelligibility, and generally provide an irregularly shaped gain curve in accordance with the measured hearing response of a specific hearing aid user, which processes have been effective in terms of enhancing the intelligibility of microphone generated speech signals; yet, in a previously unpredicted manner, such processes substantially degrade the subjective quality of multimedia sound, particularly music. Additionally, hearing aid users frequently report difficulty in acclimating to, or perceiving over time as sounding natural, multimedia sound, particularly music, when processed by the above prior art audiometric signal processes. Conversely, prior art audio signal processes provide extended and sometimes enhanced low frequency response, and ideally provide maximally regular or smooth-shaped frequency response curves as acoustically measured at a receiver or headphone comprised in an audio system, which signal processes have been effective in optimizing the naturalness of music and the intelligibility of speech, provided however that the listener of such an audio system does not have significant hearing loss.

U.S. Pat. No. 6,647,123 by Kendel claims a hearing aid having a secondary microphone exposed to sound within an ear canal in which the hearing aid is inserted, wherein an inaudible tone is generated, sensed by such secondary microphone and applied to a gain controlling negative feedback signal process in order to stabilize regenerative acoustic feedback; however, (1) no claims are made relating to the secondary microphone providing negative feedback in a non-gain control manner, as would be necessary for occlusion cancellation, (2) each claim includes an inaudible tone that is sensed by the secondary microphone and applied to such gain control negative feedback, and (3) no claims are made relating to processes or features providing enhanced lower midrange and low frequency bass acoustic output of a hearing aid, as would be necessary for natural reproduction of multimedia sound, in particular music.

PCT patent application no. PCT/US2005/013948 by the present inventor (Petroff) discloses a secondary microphone exposed to sound within an ear canal in which a hearing aid is inserted, wherein such secondary microphone generates negative feedback applied to a non-gain controlling signal process in order to cancel the occlusion effect, however the Petroff patent application does not disclose those processes and features that must be utilized in combination with such secondary microphone and negative feedback in order to provide enhanced lower midrange and low frequency bass acoustic output of a hearing aid, as necessary for natural reproduction of multimedia sound, in particular music,

Thus, prior art signal processes employed in the audiology and audio fields have been insufficiently complete or effective in terms of providing natural multimedia sound and music reproduction with extended lower midrange and bass response while simultaneously compensating for hearing loss in a hearing aid.

### SUMMARY

The present invention is an occluding hearing aid comprising anti-occlusion effect techniques with at least one improvement which, in the preferred embodiment, includes enhancement of acoustic output in the lower-midrange and bass frequency regions, typically between substantially 40 and 500 Hz, which regions are crucial for natural reproduction of multimedia sound and music but not optimally processed, and generally not provided at all, in prior art hearing aids in order to avoid exacerbation of the occlusion effect

In specific embodiments, the hearing aid constitutes a multi-faceted improvement over prior art hearing aids and comprises occlusion effect cancellation, a primary (i.e., a first) microphone exposed to external sound and a secondary microphone exposed to air conducted sound within an ear canal, in which a signal produced by the secondary microphone is applied as phase and amplitude compensated negative feedback (meaning waveform negative feedback as opposed to gain controlling negative feedback) to an input of a signal process and amplifier driving a hearing aid receiver (transducer), whereby, it has been determined by the present inventor, the occlusion effect is substantially reduced or canceled (hereinafter referred to as “occlusion effect cancellation”, and, as necessary to provide natural and extended frequency response reproduction of multimedia sound and music, at least one combinational improvement of (1) a vent having an ultra-low Helmholtz resonant frequency below one of substantially 300, 200, 150 or 100 Hz, thereby facilitating substantial acoustic generation of lower midrange and bass frequencies by a receiver comprised in the hearing aid without exacerbation of the occlusion effect by virtue of the aforementioned occlusion effect reduction or cancellation, (2) a receiver having a housing comprising at least one magnet, a magnetic circuit with an air gap, and a moving diaphragm, and further comprising at least one of (a) an ultra-long linear excursion capability greater than substantially 0.1 MM and preferably greater than one of substantially 0.15, 0.2 or 0.3 MM, (b) an ultra-low free air resonant frequency below substantially 3,000 Hz and preferably below one of substantially 2,000, 1,500 or 1,000 Hz, (c) a secondary vent having an aperture diameter between substantially 0.1 to 1.0 MM disposed on the housing of the receiver in such a position as to relieve confined acoustic waveforms occurring behind the diaphragm, wherein such secondary vent is exposed to at least one of air confined within the hearing aid case or air outside the hearing aid case, (d) at least one magnet constructed of high energy Neodymium material, thereby facilitating an ultra-large air gap greater than substantially 0.2 MM and preferably greater than one of substantially 0.3 or 0.5 MM without substantial loss of flux density within such gap, and further facilitating the aforementioned ultra-long linear excursion capability, and (e) a dual transducer configuration of the receiver comprising separate low frequency and high frequency transducers each optimized for one of a low or high frequency range, respectively, and preferably sharing a common output vent, in which one of a passive or active crossover circuit applies low and high frequency signals to the low and high frequency transducers, respectively, wherein the features of “(a)” through “(d)” apply primarily, but not necessarily exclusively, to such low frequency transducer; in each case “(a)” through “(e)” enhancing low distortion high acoustic output at low bass frequencies below substantially 100 Hz, (3) low frequency equalization substantially equal to and opposite a low frequency roll off curve of the receiver of the hearing aid as measured for the applicable vent frequency and when the hearing aid is coupled to a typical ear canal, thereby compensating for the low frequency roll off of the receiver for such vent frequency, (4) a low frequency dip substantially equal to and opposite a low frequency resonant peak of the receiver as measured when the hearing aid is coupled to a typical ear canal, thereby compensating for bass frequency resonant peaking typical of such receivers, (5) high pass filtering having a sharp cut-off slope and a cut-off frequency below the lowest frequency of usable acoustic output generated by the receiver for the applicable vent frequency, thereby preventing over-excursion and distortion of the receiver when driven at or below such lowest frequency by multimedia sound and music, (6) gain of substantially 0 to 20 dB, in magnitudes that vary inversely as a function of frequency, to lower midrange and bass frequencies between substantially 40 and 500 Hz, and preferably between substantially 40 and 200 Hz, such gain with respect to at least one of the average gain or peak gain applied to midrange frequencies comprised within the range of substantially 500 to 1,000 Hz, and preferably substantially 200 to 1,000 Hz, thereby facilitating perceptual balance of such lower midrange and bass frequencies when the hearing aid is reproducing multimedia sound, particularly music, (7) loudness compensated boost applied to lower midrange and bass frequencies below substantially 500 Hz (which frequencies, particularly in the bass region, are not ordinarily measured and corrected through audiometric processes), wherein such loudness compensation in such region one of fully applies, or preferably partially applies by substantially 25% to 75%, Fletcher-Munson equal loudness versus frequency curves, each such curve corresponding to a different SPL at a reference frequency, typically in the vicinity of 500 Hz; and, in instances where treble frequencies are also not measured and corrected through audiometric processes, loudness compensated boost applied to treble frequencies above substantially 1,000 to 4,000 Hz, wherein such loudness compensation in such region one of fully applies, or preferably partially applies, Fletcher-Munson equal loudness versus frequency curves, each such curve corresponding to a different SPL at a reference frequency, typically in the vicinity of 500 Hz, (8) low pass filtering having a cut-off frequency lying between substantially 500 and 8,000 Hz, and preferably between substantially 4,000 and 8,000 Hz, applied to the secondary microphone signal whereby the upper frequency limit of negative feedback provided by such signal is correspondingly limited for the purpose of improving the stability of such negative feedback; and gain below such cut-off frequency applied to the primary microphone signal in order to normalize effects on the frequency response of the hearing aid caused by said upper frequency cut-off of the secondary microphone signal and negative feedback, (9) (applicable when the hearing aid is linked to a multimedia sound source whether or not simultaneously amplifying microphone detected ambient sound), a signal process comprising one of (a) at least one of (i) a substantially smoothed gain curve, and (ii) less than substantially 20 dB of compression per channel, or preferably (b) a substantially smooth and flat frequency response, preferably comprising a single channel of compression, in each case “(a)” and “(b)” applied to a spectrum of frequencies between one of substantially (i) 200 and 1,000 Hz, (ii) 200 and 2,000 Hz, (iii) 200 to 4,000 Hz, (iv) 40 and 1,000 Hz, (v) 40 to 2,000 Hz, or (vi) 40 and 4,000 Hz, thereby providing optimally natural multimedia sound and music reproduction in the crucial midrange region while simultaneously allowing for gain and compression curves derived through conventional audiometric processes in the high frequency region above such spectrum to compensate for high frequency hearing loss, or (10) (applicable when the hearing aid amplifies microphone amplified ambient sound and is not linked to a multimedia sound source), a means to one of manually or automatically select between signal processes providing optimal reproduction of speech or ambient music, wherein such automatic selection comprises steps of (I) analysis in real time of the microphone detected sound whereby a predominance of speech components or music components within such sound is determined, and (II) automatic selection between signal processes (performed by a signal processor) providing optimal reproduction of speech or music, correspondingly; wherein such selected optimal reproduction of speech is provided by a signal process performed by the signal processor and comprising at least one gain curve and compression algorithm derived through conventional audiometric processes; and wherein such selected optimal reproduction of ambient music is provided by a signal process comprising one of (a) at least one of (i) a substantially smoothed gain curve, and (i) less than substantially 20 dB of compression per channel, or preferably (b) a substantially smooth and flat frequency response, preferably comprising a single channel of compression, in each case “(a)” and “(b)” applied to a spectrum of frequencies between one of substantially (i) 200 and 1,000 Hz, (ii) 200 and 2,000 Hz, (iii) 200 to 4,000 Hz, (iv) 40 and 1,000 Hz, (v) 40 to 2,000 Hz, or (vi) 40 and 4,000 Hz, thereby providing optimally natural ambient music reproduction in the crucial midrange region, while simultaneously allowing for gain and compression curves derived through conventional audiometric processes in the high frequency region above such spectrum to compensate for high frequency hearing loss.

While resonant peaks occurring in the ear canal due to the occlusion of the ear canal by the hearing aid are substantially cancelled by the occlusion cancellation process “natural” resonant peaks in the ear canal that would otherwise occur when the ear canal is open no longer exist, again due to such occlusion, and therefore such natural resonant peaks are preferably reintroduced into to the frequency response of the signal process of the hearing aid resulting in more natural and intelligible sound. In a similar manner, inherent resonant peaks in the output of the primary microphone and acoustic output of the receiver may be offset through the introduction of equal-and-opposite peaks in the frequency response of such signal process.

The hearing aid may comprise a third microphone exposed to bone conducted sound occurring about the perimeter of the ear canal in order to detect bone conducted occlusion effect related sound, in which a signal produced by the third microphone is applied as a phase and amplitude compensated second negative feedback to an input of the signal process and amplifier driving the hearing aid receiver, thereby enhancing the occlusion effect cancellation process.

It is important to note that embodiments of the present invention comprising such occlusion effect cancellation provide a multiplicity of highly significant advantages relative to prior art hearing aids even when configured and utilized strictly for microphone amplified speech and ambient music (as opposed to configured for multimedia sound or both multimedia and microphone amplified sound). This is due to the fact that the occlusion effect cancellation process, when applied in combination with a vent having an ultra-low Helmholtz resonant frequency and other features and improvements of the present invention, provides (i) more complete suppression of the occlusion effect without sacrificing naturally occurring lower mid frequency speech components, (ii) more natural and pleasant sounding amplified speech as a consequence of such amplification of lower mid frequency speech components, (iii) dramatic improvements in the quality microphone amplified ambient music due to the reproduction of lower mid and bass frequencies, and (v) improved frequency response linearity and lower distortion of the receiver acoustic output, and consequently the entire hearing aid, as a consequence of the in-the-canal acoustic negative feedback associated with the occlusion cancellation process. Thus, the principles and processes of the present invention enable the occlusion effect related advantages of non-occluding hearing aids to be equivalently applied to occluding hearing aids, while simultaneously enabling lower mid and bass frequency reproduction, as well as retaining the inherent advantages of occluding hearing aids in terms of greater maximum gain, lower mid frequency compensation capability, and, for CIC devices, lack of visibility.

In additional specific embodiments, the hearing aid does not comprise occlusion effect cancellation and instead comprises a substantially equivalent alternative thereto consisting of at least one of an automatically selectable frequency vent (ASFV) or user selectable frequency vent (USFV), which in each case are selectable between at least two Helmholtz resonant frequencies, including (a) a high frequency between substantially 1,000 and 200 Hz, and preferably between substantially 500 and 200 Hz, in order to minimize the occlusion effect when the hearing aid is not linked to a multimedia sound source, and (b) a low frequency between substantially 200 and 40 Hz in order to optimize music reproduction in the lower midrange and bass frequencies when the hearing aid is linked to a multimedia sound source whether or not such hearing aid simultaneously reproduces microphone generated speech (the primary objective of the user when the hearing aid is linked to a sound source is generally to listen to such sound source rather than to speak and therefore the occlusion effect is typically not critical during such times), and, as necessary to provide optimally natural and extended frequency response reproduction of multimedia sound and music, may further comprise at least one combinational feature of (1) a receiver having a housing comprising at least one magnet, a magnetic circuit with an air gap, and a moving diaphragm, and further comprising at least one of (a) an ultra-long linear excursion capability greater than substantially 0.1 MM and preferably greater than 0.15, 0.2 or 0.3 MM, (b) an ultra-low free air resonant frequency below substantially 3,000 Hz and preferably below substantially one of 2,000, 1,500 or 1,000 Hz, (c) a secondary vent having an aperture diameter between substantially 0.1 to 1.0 MM disposed on the housing of the receiver in such a position as to relieve confined acoustic waveforms occurring behind the diaphragm, wherein such secondary vent is exposed to at least one of air confined within the hearing aid case or air outside the hearing aid case, (d) at least one magnet constructed of high energy Neodymium material, thereby facilitating an ultra-large air gap greater than substantially 0.2 MM and preferably greater than 0.3 or 0.5 MM, without substantial loss of flux density within such gap, and further facilitating the aforementioned ultra-long linear excursion capability, and (e) a dual transducer configuration of the receiver comprising separate low frequency and high frequency transducers each optimized for one of a low or high frequency range, respectively, and preferably sharing a common output vent, in which one of a passive or active crossover circuit applies low and high frequency signals to the low and high frequency transducers, respectively.

The features of “(a)” through “(d)” apply primarily, but not necessarily exclusively, to such low frequency transducer; in each case “(a)” through “(e)” enhancing low distortion high acoustic output at low bass frequencies below substantially 100 Hz, (2) low frequency equalization substantially equal to and opposite a low frequency roll off curve of the receiver of the hearing aid as measured for the applicable vent frequency and when the hearing aid is coupled to a typical ear canal, thereby compensating for the low frequency roll of the receiver for such vent frequency, (3) a low frequency dip substantially equal to and opposite a low frequency resonant peak of the receiver as measured when the hearing aid is coupled to a typical ear canal, thereby compensating for bass frequency resonant peaking typical of such receivers, (4) high pass filtering having a sharp cut-off slope and a cut-off frequency below the lowest frequency of usable acoustic output generated by the receiver for the applicable vent frequency, thereby preventing over-excursion and distortion of the receiver when driven at or below such lowest frequency by multimedia sound and music, (5) gain of substantially 0 to 20 dB, preferably in magnitudes that vary inversely as a function of frequency, to lower midrange and bass frequencies between substantially 40 and 500 Hz, and preferably between substantially 40 and 150 Hz, such gain with respect to at least one of the average gain or peak gain applied to midrange frequencies comprised within the range of substantially 500 to 1,000 Hz, and preferably substantially 200 to 1,000 Hz, thereby facilitating perceptual balance of such lower midrange and bass frequencies when the hearing aid is reproducing multimedia sound, particularly music, (6) loudness compensated boost applied to lower midrange and bass frequencies below substantially 500 Hz (which frequencies, particularly in the bass region, are not ordinarily measured and corrected through audiometric processes), wherein such loudness compensation in such region one of fully applies, or preferably partially applies by substantially 25% to 75%, Fletcher-Munson equal loudness versus frequency curves, each such curve corresponding to a different SPL at a reference frequency, typically in the vicinity of 500 Hz; and, in instances where treble frequencies are also not measured and corrected through audiometric processes, loudness compensated boost applied to treble frequencies above substantially 1,000 to 4,000 Hz, wherein such loudness compensation in such region one of fully applies, or preferably partially applies, Fletcher-Munson equal loudness versus frequency curves, each such curve corresponding to a different SPL at a reference frequency, typically in the vicinity of 500 Hz, (7) (applicable when the hearing aid is linked to a multimedia sound source whether or not simultaneously amplifying microphone detected ambient sound), a signal processor performed a signal process comprising one of (a) at least one of (i) a substantially smoothed gain curve, and (ii) less than substantially 20 dB of compression per channel, or preferably (b) a substantially smooth and flat frequency response, preferably comprising a single channel of compression, in each case “(a)” and “(b)” applied to a spectrum of frequencies between one of substantially (i) 200 and 1,000 Hz, (ii) 200 and 2,000 Hz, (iii) 200 to 4,000 Hz, (iv) 40 and 1,000 Hz, (v) 40 to 2,000 Hz, or (vi) 40 and 4,000 Hz, thereby providing optimally natural multimedia sound and music reproduction in the crucial midrange region while simultaneously allowing for gain and compression curves derived through conventional audiometric processes in the high frequency region above such spectrum to compensate for high frequency hearing loss, or (8) (applicable when the hearing aid amplifies microphone amplified ambient sound and is not linked to a multimedia sound source), a means to one of manually or automatically select between signal processes providing optimal reproduction of speech or ambient music, wherein such automatic selection comprises steps of (I) analysis in real time of the microphone detected sound whereby a predominance of speech components or music components within such sound is determined, and (II) automatic selection between signal processes providing optimal reproduction of speech or music, correspondingly; wherein such selected optimal reproduction of speech is provided by a signal process comprising at least one gain curve and compression algorithm derived through conventional audiometric processes; and wherein such selected optimal reproduction of ambient music is provided by a signal process performed by a signal processor comprising one of (a) at least one of (i) a substantially smoothed gain curve, and (i) less than substantially 20 dB of compression per channel, or preferably (b) a substantially smooth and flat frequency response, preferably comprising a single channel of compression, in each case “(a)” and “(b)” applied to a spectrum of frequencies between one of substantially (i) 200 and 1,000 Hz, (ii) 200 and 2,000 Hz, (iii) 200 to 4,000 Hz, (iv) 40 and 1,000 Hz, (v) 40 to 2,000 Hz, or (vi) 40 and 4,000 Hz, thereby providing optimally natural ambient music reproduction in the crucial midrange region, while simultaneously allowing for gain and compression curves derived through conventional audiometric processes in the high frequency region above such spectrum to compensate for high frequency hearing loss.

In the above embodiments of the present invention that do not include occlusion effect cancellation, resonant peaks occurring in the ear canal due to the occlusion of the ear canal by the hearing aid are preferably subtracted from the frequency response of the hearing aid, and “natural” resonant peaks in the ear canal that would otherwise occur when the ear canal is open on longer exist due to such occlusion are preferably added to the frequency response of the hearing aid, in both cases resulting in more natural and intelligible sound. In a similar manner, inherent resonant peaks in the output of the primary microphone and acoustic output of the receiver may be offset through the introduction of equal-and-opposite peaks in the frequency response of such signal process.

Automatic selection of the ASFV vent frequency may be determined by one of: (1) detecting a presence of an active hearing aid link to a multimedia sound source, whether or not the hearing aid simultaneously reproduces microphone generated speech, in which case the vent is automatically selected for a low Helmholtz resonant frequency in order to optimize multimedia sound and music reproduction in the lower midrange and bass frequencies, or detecting an absence of an active hearing aid link to a multimedia sound source (thereby indicating strictly microphone generated sound amplification) in which case the vent is automatically selected for a high Helmholtz resonant frequency in order to minimize the occlusion effect; (2) detection of an active hearing aid link to a multimedia sound source, whether or not the hearing aid simultaneously reproduces microphone generated speech, in which case the vent is automatically selected for a low Helmholtz resonant frequency in order to optimize multimedia sound and music reproduction, or detection of the absence of an active hearing aid link to a multimedia sound source in which case the automatic selection is determined by analysis in real time of speech versus music components in the microphone generated sound, whereby a predominance of speech components results in the vent automatically selected for a high Helmholtz resonant frequency in order to minimize the occlusion effect, and whereby a predominance of music components results in the vent automatically selected for a low Helmholtz resonant frequency in order to optimize microphone generated ambient music reproduction; or (3) whether or not the hearing aid is linked to a multimedia sound source, analysis in real time of speech versus music components comprised in the microphone generated sound, whereby a predominance of speech components results in the vent automatically selected for a high Helmholtz resonant frequency in order to minimize the occlusion effect, and whereby a predominance of music components results in the vent automatically selected for a low Helmholtz resonant frequency in order to optimize microphone generated ambient music reproduction.

The ASFV and USFV vents are in each case adjustable between at least a low and a high Helmholtz resonant frequency and comprised of one of (1) an aperture disposed on the hearing aid case, or (2) a cylinder disposed on the hearing aid case and having a cross-sectional area, a cylinder length, a first open end exposed to the interior of the hearing aid case, and a second open end exposed to the outside of the hearing aid case.

Where the ASFV is comprised of an aperture, the cross-sectional area of the aperture may be adjusted by means an electromechanical actuator coupled to one of (a) a movable shroud that blocks adjustable portions of such cross-sectional area, or (b) at least one side of a distortable such aperture whereby such actuator alters the cross-sectional area of such aperture; wherein the previously described automatic selection means controls such electromagnetic actuator and aperture, and thereby determines the Helmholtz resonant frequency of the aperture of the ASFV vent.

Where the ASFV is comprised of a cylinder, the length of the cylinder may be adjusted by means of an electromechanical actuator coupled to one of (a) a movable telescopic section of such cylinder to adjust a length of the cylinder, or (b) a least one side of a distortable such cylinder whereby such actuator alters the shape (meaning at least one of the length or cross-sectional area) of such cylinder; wherein the previously described automatic selection means controls such electromagnetic actuator and cylinder, and thereby determines the Helmholtz resonant frequency of the cylinder of the ASFV vent.

The USFV is made up of an aperture where the cross-sectional area of the aperture may be adjusted by means of one of: (1) a mechanical linkage having a first end coupled to one of (a) a movable shroud that blocks adjustable portions of such cross-sectional area, or (b) at least one side of a distortable such aperture whereby the linkage alters the cross-sectional area of such aperture, and a second end of the linkage exposed to the outside of the hearing aid case and which is manually adjusted in such a manner as to alter the cross-sectional area and consequently the Helmholtz resonant frequency of such aperture of the USFV vent; or (2) an electromechanical mechanism that substitutes the mechanical linkage and is user adjusted by means of an electronic control that may be disposed on at least one of the hearing aid case or a wireless controller.

The USFV is made up of a cylinder, where the length of the cylinder may be adjusted by means of one of: (1) a mechanical linkage having a first end coupled to one of (a) a movable telescopic section of such cylinders or (b) at least one side of a distortable such cylinder whereby the linkage alters the shape (meaning at least one of the length or cross-sectional area) of said cylinder, and a second end of the linkage exposed to the outside of the hearing aid case and which is manually adjusted in such a manner as to alter the shape and consequently the Helmholtz resonant frequency of such cylinder of the USFV vent; or (2) an electromechanical mechanism that substitutes the mechanical linkage and is user adjusted by means of an electronic control that may be disposed on at least one of the hearing aid case or a wireless controller. Other mechanical and electromechanical mechanisms not described herein, but providing equivalent control over the shape, length or cross-sectional area of a ASFV or USFV vent, as is applicable, and in such a manner as to alter the Helmholtz resonant frequency of such vent, may substitute the previously described mechanical and electromechanical mechanisms without altering the principals, functions and advantages of the present invention.

Although the present invention applies primarily to hearing aids, the principles, processes, features and advantages of the present invention may also be applied to an assistive listening device (ALD), such ALD application typically comprising substitution of the hearing aid receiver for each ear of a user with at least one of an earbud, headphone or speaker, and typically substituting the hearing aid case with a larger case more suitable for ALD applications.

Other features of the present invention will become apparent from the following descriptions considered in conjunction with the accompanying drawings. The drawings are merely intended to conceptually and symbolically illustrate the principles, processes and functions described herein. Designated letters and numbers in each of the following drawings correspond to designated letters and numbers in the remaining drawings.

### BRIEF DESCRIPTION OF THE DRAWINGS

In the drawings wherein like reference numerals depict similar elements throughout the views:

FIG. 1 is a block diagram of a first prior art hearing aid.

FIG. 2 is a block diagram of second prior art hearing aid.

FIG. 3 is a block diagram of the preferred embodiment of a hearing aid of the present invention.

FIG. 4 is a block diagram of a first alternative embodiment of a hearing aid of the present invention.

FIG. 5 is a block diagram of a second alternative embodiment of a hearing aid of the present invention.

FIG. 6 is a block diagram of a third alternative embodiment of a hearing aid of the present invention.

FIG. 7 is a block diagram of a dual transducer receiver of a hearing aid of the present invention.

FIG. 8a is a block diagram of a first automatically selected frequency vent of a hearing aid of the present invention.

FIG. 8b is a block diagram of a second automatically selected frequency vent of a hearing aid of the present invention.

FIG. 9a is a block diagram of a third automatically selected frequency vent of a hearing aid of the present invention.

FIG. 9b is a block diagram of a fourth automatically selected frequency vent of a hearing aid of the present invention.

FIG. 10a is a block diagram of a first user selected frequency vent of a hearing aid of the present invention.

FIG. 10b is a block diagram of a second user selected frequency vent of a hearing aid of the present invention.

FIG. 11a is a block diagram of a third user selected frequency vent of a hearing aid of the present invention.

FIG. 11b is a block diagram of a fourth user selected frequency vent of a hearing aid of the present invention.

### DETAILED DESCRIPTION OF PREFERRED EMBODIMENTS

In the preferred embodiment, the hearing aid constitutes a multi-faceted improvement over prior art hearing aids and comprises occlusion effect cancellation, a primary microphone exposed to external sound and a secondary microphone exposed to air conducted sound within an ear canal, in which a signal produced by the secondary microphone is applied as phase and amplitude compensated negative feedback (meaning waveform negative feedback as opposed to gain controlling negative feedback) to an input of a signal process and amplifier driving a hearing aid receiver (transducer), whereby, it has been determined by the present inventor, the occlusion effect may be substantially canceled, and, as necessary to provide optimally natural and extended frequency response reproduction of multimedia sound and music, combinational improvements of:

(1) a vent having an ultra-low Helmholtz resonant frequency of substantially 40 Hz, thereby facilitating substantial acoustic generation of lower midrange and bass frequencies by a receiver comprised in the hearing aid without exacerbation of the occlusion effect by virtue of the aforementioned occlusion effect cancellation;

(2) a receiver having a housing comprising two magnets, a magnetic circuit with an air gap, and a moving diaphragm, and further comprising at least one of (a) an ultra-long linear excursion capability of substantially 0.2 MM, (b) an ultra-low free-air resonant frequency of substantially 400 Hz, (c) a secondary vent consisting of a hole of substantially 0.5 MM in diameter disposed on the housing of the receiver in such a position as to relieve confined acoustic waveforms occurring behind the diaphragm, wherein such secondary vent is exposed to air confined within the hearing aid case, (d) two magnets constructed of high energy Neodymium material, thereby facilitating an extremely large magnetic air gap of substantially 0.3 MM without substantial loss of flux density within such gap and further facilitating the aforementioned ultra-long linear excursion capability, and (e) a dual transducer configuration of the receiver comprising separate low frequency and high frequency transducers each optimized for one of a low or high frequency range, respectively, and sharing a common output vent, in which a passive crossover circuit applies low and high frequency signals to the low and high frequency transducers, respectively, wherein the features of “(a)” through “(d)” apply to the low frequency transducer; in each case “(a)” through “(e)” enhancing low distortion high acoustic output at low bass frequencies below substantially 100 Hz;

(3) low frequency equalization substantially equal to and opposite a low frequency roll off curve of the receiver of the hearing aid as measured for the applicable vent frequency and when the hearing aid is coupled to a typical ear canal, thereby compensating for the low frequency roll off of the receiver for such vent frequency;

(4) a low frequency dip substantially equal to and opposite a low frequency resonant peak of the receiver as measured when the hearing aid is coupled to a typical ear canal, thereby compensating for bass frequency resonant peaking typical of such receivers;

(5) high pass filtering having a sharp cut-off slope and a cut-off frequency below the lowest frequency of usable acoustic output generated by the receiver for the applicable vent frequency, thereby preventing over-excursion and distortion of the receiver when driven at or below such lowest frequency by multimedia sound and music;

(6) gain of substantially 6 dB, preferably in magnitudes that vary inversely as a function of frequency, to lower midrange and bass frequencies between substantially 40 and 200 Hz, such gain with respect to at least one of the average gain or peak gain applied to midrange frequencies comprised within the range of substantially 200 to 1,000 Hz, thereby facilitating perceptual balance of such lower midrange and bass frequencies when the hearing aid is reproducing multimedia sound, particularly music;

(7) loudness compensated boost applied to lower midrange and bass frequencies below substantially 500 Hz (which frequencies, particularly in the bass region, are not ordinarily measured and corrected through audiometric processes), wherein such loudness compensation in such region partially applies by substantially 50% Fletcher-Munson equal loudness versus frequency curves, each such curve corresponding to a different SPL at a reference frequency, typically in the vicinity of 500 Hz; and, in instances where treble frequencies are also not measured and corrected through audiometric processes, loudness compensated boost applied to treble frequencies above substantially 4,000 Hz, wherein such loudness compensation in such region one of fully applies, or preferably partially applies, Fletcher-Munson equal loudness versus frequency curves, each such curve corresponding to a different SPL at a reference frequency, typically in the vicinity of 500 Hz;

(8) low pass filtering having a cut-off frequency lying between substantially 500 and 8,000 Hz, and preferably between substantially 4,000 and 8,000 Hz, applied to the secondary microphone signal whereby the upper frequency limit of negative feedback provided by such signal is correspondingly limited for the purpose of improving the stability of such negative feedback; and gain below such cut-off frequency applied to the primary microphone signal in order to normalize effects on the frequency response of the hearing aid caused by said upper frequency cut-off of the secondary microphone signal and negative feedback;

(9) (applicable when the hearing aid is linked to a multimedia sound source whether or not simultaneously amplifying microphone detected ambient sound), a signal process comprising a substantially smooth and flat frequency response and a single channel of compression, such frequency response and compression applied to a spectrum of frequencies between 200 and 2,000 Hz, thereby providing optimally natural multimedia sound and music reproduction in the crucial midrange region while simultaneously allowing for gain and compression curves derived through conventional audiometric processes in the high frequency region above such spectrum to compensate for high frequency hearing loss; or

(10) (applicable when the hearing aid amplifies microphone amplified ambient sound and is not linked to a multimedia sound source), a means to automatically select between signal processes providing optimal reproduction of speech or ambient music, wherein such automatic selection comprises steps of (I) analysis in real time of the microphone detected sound whereby a predominance of speech components or music components within such sound is determined, and (II) automatic selection between signal processes providing optimal reproduction of speech or music, correspondingly; wherein such selected optimal reproduction of speech is provided by a signal process comprising a gain curve and compression algorithm derived through conventional audiometric processes; and wherein such selected optimal reproduction of ambient music is provided by a signal process comprising a substantially smooth and flat frequency response and a single channel of compression, such frequency response and compression applied to a spectrum of frequencies between substantially 200 and 2,000 Hz, thereby providing optimally natural ambient music reproduction in the crucial midrange region, while simultaneously allowing for gain and compression curves derived through conventional audiometric processes in the high frequency region above such spectrum to compensate for high frequency hearing loss.

While resonant peaks occurring in the ear canal due to the occlusion of the ear canal by the hearing aid are substantially cancelled by the occlusion cancellation process “natural” resonant peaks in the ear canal that would otherwise occur when the ear canal is open no longer exist, again due to such occlusion, and therefore such natural resonant peaks are reintroduced into to the frequency response of the signal process of the hearing aid resulting in more natural and intelligible sound. In a similar manner, inherent resonant peaks in the output of the primary microphone and acoustic output of the receiver are offset (negated) through the introduction of equal-and-opposite peaks in the frequency response of such signal process.

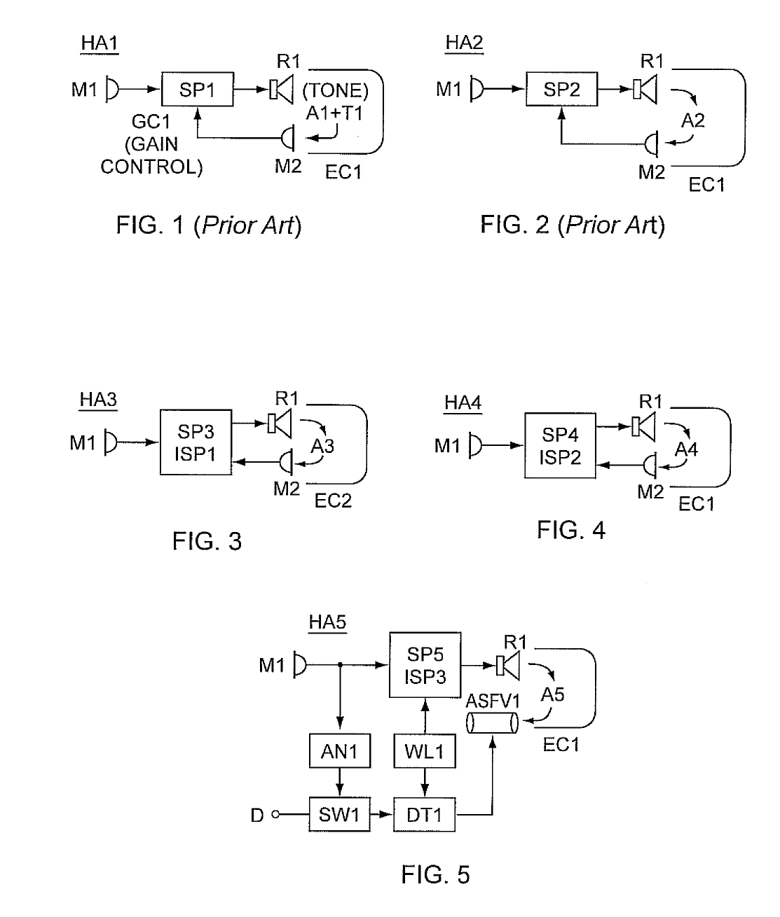

FIG. 1 is a block diagram of a first prior art hearing aid HA1 in accordance with U.S. Pat. No. 6,647,123 by Kendel, in which primary microphone M1 is exposed to external sound and coupled as audio input to gain controlled signal processor SP1. As used herein, the term “signal process” refers to the signal processing performed by the signal processor and such term “signal process” can be interchangeable with “signal processor” without departing from the invention. Receiver R1 is acoustically coupled to ear canal EC1, in which the hearing aid is inserted, and produces acoustic output A1 plus inaudible tone T1. Secondary microphone M2 senses A1+T1 and is coupled as gain control input GC1 of signal process SP1. The hearing aid utilizes such tone, secondary microphone and gain controlled signal process to stabilize regenerative acoustic feedback.

FIG. 2 is a block diagram of second prior art hearing aid HA2 in accordance with published PCT application # PC/US2005/013948 by Petroff, in which primary microphone M1 is exposed to external sound and coupled as audio input to non-gain controlled signal process SP2. Receiver R1 is acoustically coupled to ear canal EC1, in which the hearing aid is inserted, and produces acoustic output A2. Secondary microphone M2 senses acoustic output A2 and is coupled as negative feedback to signal process SP2. Said hearing aid thereby cancels the occlusion effect.

FIG. 3 is a block diagram of hearing aid HA3 of the preferred embodiment of the present invention comprising occlusion effect cancellation, in which primary microphone M1 is exposed to external sound and coupled as audio input to non-gain controlled signal process SP3. Receiver R1 is acoustically coupled to ear canal EC1, in which the hearing aid is inserted, and produces acoustic output A3. Secondary microphone M2 senses acoustic output A3 and is coupled as negative feedback to signal process SP3. SP3 comprises improved signal processes ISP1 described in the Description of the Preferred Embodiment of the present invention, which processes are implicit in signal process block SP3 of this block diagram The preferred embodiment thereby cancels the occlusion effect while simultaneously providing extended frequency response reproduction of multimedia sound.

FIG. 4 is a block diagram of hearing aid HA4 of a first alternative embodiment of the present invention comprising occlusion effect cancellation, in which primary microphone M1 is exposed to external sound and coupled as audio input to non-gain controlled signal process SP4. Receiver R1 is acoustically coupled to ear canal EC1, in which the hearing aid is inserted, and produces acoustic output A4. Secondary microphone M2 senses acoustic output A4 and is coupled as negative feedback to signal process SP4. Hearing aid H4 further comprises third microphone M3 exposed to bone conducted sound occurring about perimeter P1 of ear canal EC1 to detect bone conducted occlusion effect related sound. M3 is coupled to SP4 in an additional non-gain controlled negative feedback signal process. SP4 comprises improved signal processes ISP2 described in the Summary of the Invention for “specific embodiments” of the present invention, which processes are implicit in signal process block SP4 of this block diagram. The first alternative embodiment thereby cancels the occlusion effect while simultaneously providing extended frequency response reproduction of multimedia sound.

FIG. 5 is a block diagram of a second alternative embodiment of a hearing aid HAS of the present invention not comprising occlusion effect cancellation however incorporating a substantially equivalent alternative thereto, in which primary microphone M1 is exposed to external sound and coupled as audio input to non-gain controlled signal process SP5. SP5 comprises improved signal processes ISP3 described in the Summary of the Invention for “additional specific embodiments” of the present invention, which processes are implicit in signal process block SP5 of this block diagram Receiver R1 is acoustically coupled to ear canal EC1, in which the hearing aid is inserted, and produces acoustic output A5. Hearing aid HA5 further comprises first automatically selectable frequency vent ASFV1 interposed between ear canal EC1 and the outside, in which such vent is selectable between a high and a low Helmholtz resonant frequency as determined by (1) detector DT1 detecting an interconnection of wireless link WL1 to a multimedia sound source whereby WL1 provides a multimedia input signal to SP5, in which case ASFV1 is automatically selected for such low Helmholtz resonant frequency, or (2) DT1 detecting an absence of active hearing aid link AL1 to multimedia sound source MS1, in which case ASFV1 is determined, through logic switch SW1, by one of (a) default state D to such low Helmholtz resonant frequency, or (b) analyzer AN1 of speech versus music components from microphone M1, whereby a predominance of speech components results in ASFV1 automatically selected for such high Helmholtz resonant frequency and a predominance of music components results in ASFV1 selected for such low Helmholtz resonant frequency. SP5 comprises improved signal processes ISP3 described in the Summary of the Invention for “additional specific embodiments” of the present invention, which processes are implicit in signal process block SP5 of this block diagram. The second alternative embodiment thus minimizes the occlusion effect while simultaneously providing extended frequency response reproduction of such multimedia sound.

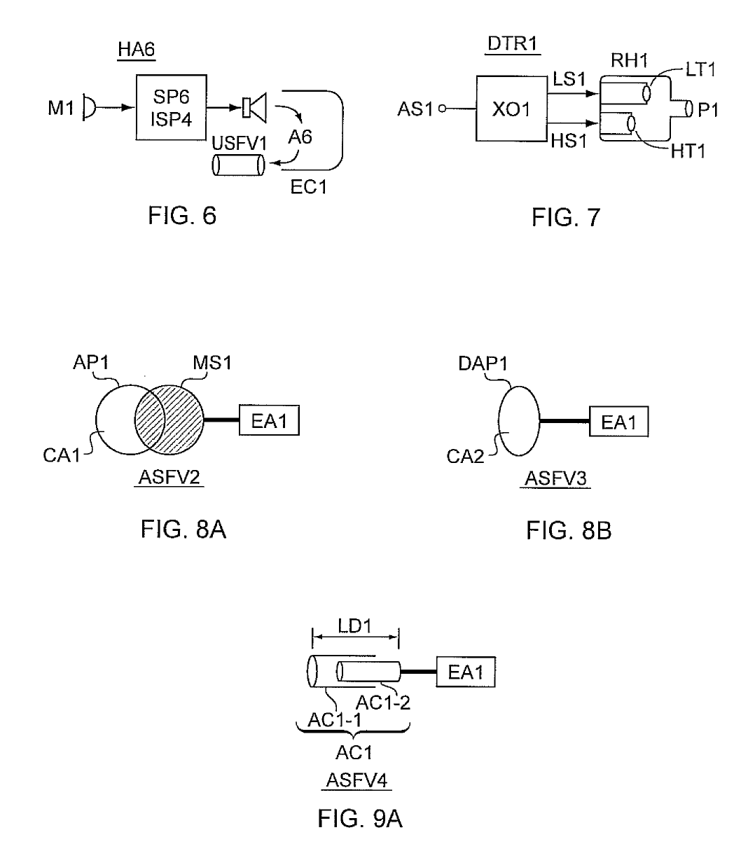

FIG. 6 is a block diagram of a third alternative embodiment of a hearing aid HA6 of the present invention not comprising occlusion effect cancellation however incorporating a substantially equivalent alternative thereto, in which primary microphone M1 is exposed to external sound and coupled as audio input to non-gain controlled signal process SP6. Receiver R1 is acoustically coupled to ear canal EC1, in which the hearing aid is inserted, and produces acoustic output A6. HA6 further comprises first user selectable frequency vent USFV1 interposed between ear canal EC1 and the outside. SP6 comprises improved signal processes ISP4 described in the Summary of the Invention for “additional specific embodiments” of the present invention, which processes are implicit in signal process block SP6 of this block diagram. The second alternative embodiment thereby minimizes the occlusion effect while simultaneously providing extended frequency response reproduction of multimedia sound.

FIG. 7 is a block diagram of dual transducer receiver DTR1 of a hearing aid of the present invention, in which low frequency transducer LT1 and high frequency transducer HT1 are comprised in receiver housing RH1, wherein LT1 and HT1 each acoustically couple to receiver output port P1, and wherein crossover XO1 receives as input audio power signal AS1 and provides as outputs low frequency filtered audio power signal LS1 and high frequency filtered audio power signal HS1. LS1 and HS1 are applied as input to transducers LT1 and HT1, respectively. Receiver DTR1 comprises features and characteristics described in the Summary of the Invention for “additional specific embodiments” of the present invention and which are implicit in this block diagram.

FIG. 8a is a block diagram of second automatically selected frequency vent ASFV2 of a hearing aid of the present invention comprising aperture AP1 having a cross-sectional area CA1 that is adjusted by means of electromechanical actuator EA1 coupled to movable shroud MS1 that blocks adjustable portions of CA1 in such a manner as to alter such area and consequently the Helmholtz resonant frequency of said vent.

FIG. 8b is a block diagram of third automatically selected frequency vent ASFV3 of a hearing aid of the present invention comprising distortable shape aperture DAP1 having a cross-sectional area CA2 that is adjusted by means of electromagnetic actuator EA1 coupled to DAP1 in such a manner as to alter such area and consequently the Helmholtz resonant frequency of said vent

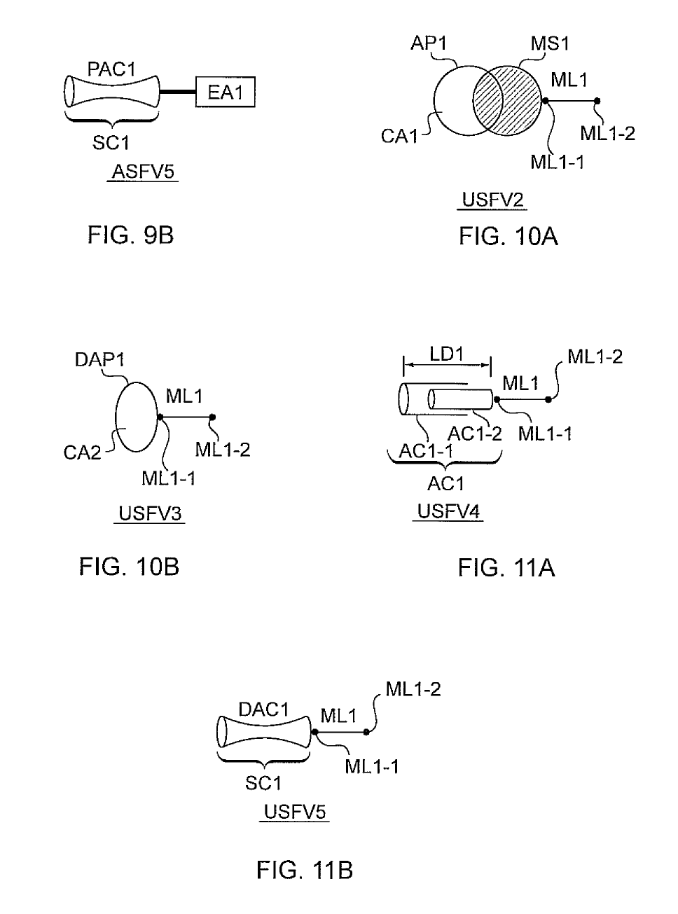

FIG. 9a is a block diagram of fourth automatically selected frequency vent ASFV4 of a hearing aid of the present invention comprising adjustable length cylinder AC1 having length dimension LD1, incorporating fixed section AC1-1 and telescopic section AC1-2, and adjusted by means of electromechanical actuator EA1 coupled to AC1-2 in such a manner as to alter such length dimension and consequently the Helmholtz resonant frequency of said vent.

FIG. 9b is a block diagram of fifth automatically selected frequency vent ASFV5 of a hearing aid of the present invention, in which ASFV5 comprising distortable shape cylinder DAC1 having a shape configuration SC1 that is adjusted by means of electromagnetic actuator EA1 coupled to DAC1 in such a manner as to alter such shape configuration and consequently the Helmholtz resonant frequency of said vent.

FIG. 10a is a block diagram of second user selected frequency vent USFV2 of a hearing aid of the present invention comprising aperture AP1 having cross-sectional area CA1 that is adjusted by means of mechanical linkage ML1. ML1 has a first end ML1-1 coupled to movable shroud MS1 that blocks adjustable portions of CA1, and a second end ML1-2 exposed to the outside, and which is manually adjusted in such a manner as to alter such area and consequently the Helmholtz resonant frequency of said vent.

FIG. 10b is a block diagram of third user selected frequency vent USFV3 of a hearing aid of the present invention comprising distortable aperture DAP1 having a cross-sectional area CA2 that is adjusted by means of mechanical linkage ML1. ML1 has a first end ML1-1 coupled to DAP1, and a second end ML1-2 exposed to the outside, and which is manually adjusted in such a manner as to alter such area and consequently the Helmholtz resonant frequency of said vent.

FIG. 11a is a block diagram of fourth user selected frequency vent USFV4 of a hearing aid of the present invention comprising adjustable length cylinder AC1 having length dimension LD-1, incorporating fixed section AC1-1 and telescopic section AC1-2, and adjusted by means of mechanical linkage ML1. ML1 comprises a first end ML1-1 coupled to telescopic section AC1-2, and a second end ML1-2 exposed to the outside and which is manually adjusted in such a manner as to alter such length dimension and consequently the Helmholtz resonant frequency of said vent.

FIG. 11b is a block diagram of a fifth user selected frequency vent USFV5 of a hearing aid of the present invention, in which USFV5 comprising distortable shape cylinder DAC1 having a shape configuration SC1 that is adjusted by means of a mechanical linkage ML1. ML1 comprises a first end ML1-1 coupled to distortable cylinder DAC1, and a second end ML1-2 exposed to the outside and which is manually adjusted in such a manner as to alter such shape configuration and consequently the Helmholtz resonant frequency of said vent.

What is claimed is:

1. An improved hearing aid inserted into an ear canal and having a seal that substantially isolates external sound outside the ear canal from internal sound within the ear canal, the hearing aid comprising:
a vent having a low Helmholtz resonant frequency below one of substantially 300 Hz, 200 Hz, 150 Hz or 100 Hz and disposed on the hearing aid whereby the external sound may vent to the internal sound below said resonant frequency;
a first microphone exposed to the external sound and generating a first microphone signal;
a second microphone exposed to the internal sound and generating a second microphone signal;
a signal processor receiving as a first input the first microphone signal,
occlusion effect cancellation by means of applying the second microphone signal as phase and amplitude compensated waveform negative feedback to a second input of the signal processor; and
an amplifier receiving as input an output of said signal processor and driving a hearing aid receiver that generates such internal sound;
wherein the hearing aid includes acoustic output enhancement features operating in the lower-midrange and bass frequency regions crucial for natural reproduction of multimedia sound and music, said acoustic output enhancement features are provided by one selected from a group consisting of:
a. a receiver having a housing comprising at least one magnet, a magnetic circuit with an air gap, and a moving diaphragm, and further comprising at least one of (i) an ultra-long linear excursion capability greater than one of substantially 0.1 MM, 0.15 MM, 0.2 MM or 0.3 MM, (ii) an ultra-low free air resonant frequency below one of substantially 3,000 Hz, 2,000 Hz, 1,500 Hz or 1,000 Hz, (iii) a secondary vent having an aperture diameter between substantially 0.1 MM to 1.0 MM disposed on the housing of the receiver in such a position as to relieve confined acoustic waveforms occurring behind the diaphragm, wherein such secondary vent is exposed to at least one of air confined within the hearing aid case or air outside the hearing aid case, (iv) at least one magnet constructed of high energy Neodymium material, thereby facilitating an ultra-large air gap greater than one of substantially 0.2 MM, 0.3 MM or 0.5 MM, and (v) a dual transducer configuration of the receiver comprising separate low frequency and high frequency transducers each optimized for one of a low or high frequency range, respectively, and optionally sharing a common output vent, in which one of a passive or active crossover circuit applies low and high frequency signals to the low and high frequency transducers, respectively;
b. low frequency equalization substantially equal to and opposite a low frequency roll off curve of the receiver of the hearing aid as measured for the applicable vent frequency when the hearing aid is coupled to an ear canal;
c. a low frequency dip substantially equal to and opposite a low frequency resonant peak of the receiver as measured when the hearing aid is coupled to an ear canal;
d. high pass filtering having a sharp cut-off slope and a cut-off frequency below substantially the lowest frequency of usable acoustic output generated by the receiver for the applicable vent frequency;
e. gain in the range of substantially 0 to 20 dB and which varies inversely as a function of frequency applied to lower midrange and bass frequencies between one of substantially 40 and 500 Hz or 40 and 200 Hz, such gain with respect to at least one of the average gain or peak gain applied to midrange frequencies comprised within the range of one of substantially 500 to 1,000 Hz or 200 to 1,000 Hz;
f. loudness compensation boost applied to at least one of (i) lower midrange and bass frequencies below substantially 500 Hz, and (ii) treble frequencies above substantially 1,000 to 4,000 Hz, said loudness compensation one of fully applies, or partially applies by substantially 25% to 75%, equal loudness versus frequency curves, eac2h such curve corresponding to a different SPL at a reference frequency;
g. low pass filtering having a cut-off frequency lying between substantially 500 and 8,000 Hz applied to the secondary microphone signal to improve the stability of such negative feedback, and gain below such cut-off frequency applied to the primary microphone signal to normalize effects on the frequency response of the hearing aid caused by such frequency cut-off of said negative feedback;
h. a substantially smoothed gain curve applied to a spectrum of lower midrange and bass frequencies between one of substantially 200 to 1,000 Hz, 200 to 2,000 Hz, 200 to 4,000 Hz, 40 to 1,000 Hz, 40 to 2,000 Hz, or 40 to 4,000 Hz;
i. less than substantially 20 dB of compression per channel applied to a spectrum of lower midrange and bass frequencies between one of substantially 200 to 1,000 Hz, 200 to 2,000 Hz, 200 to 4,000 Hz, 40 to 1,000 Hz, 40 to 2,000 Hz, or 40 to 4,000 Hz;
j. a substantially smoothed and flat frequency response applied to a spectrum of lower midrange and bass frequencies between one of substantially 200 to 1,000 Hz, 200 to 2,000 Hz, 200 to 4,000 Hz, 40 to 1,000 Hz, 40 to 2,000 Hz, or 40 to 4,000 Hz; and
k. a single channel of compression applied to a spectrum of lower midrange and bass frequencies between one of substantially 200 to 1,000 Hz, 200 to 2,000 Hz, 200 to 4,000 Hz, 40 to 1,000 Hz, 40 to 2,000 Hz, or 40 to 4,000 Hz.

2. The hearing aid according to claim 1, further comprising:
a third microphone exposed to bone conducted sound occurring about the perimeter of the ear canal in order to detect bone conducted occlusion effect related sound wherein a signal produced by the third microphone is applied as a second phase and amplitude compensated waveform negative feedback to an input of the signal processor and amplifier driving the hearing aid receiver, thereby enhancing said occlusion effect cancellation process.

3. An improved hearing aid inserted into an ear canal and having a seal that substantially isolates external sound outside the ear canal from internal sound within the ear canal, the hearing aid comprising:
a vent having a low Helmholtz resonant frequency below one of substantially 300 Hz, 200 Hz, 150 Hz or 100 Hz and disposed on the hearing aid whereby the external sound may vent to the internal sound below said resonant frequency;
a first microphone exposed to the external sound and generating a first microphone signal;
a second microphone exposed to the internal sound and generating a second microphone signal;
a signal processor receiving as a first input the first microphone signal, occlusion effect cancellation by means of applying the second microphone signal as waveform negative feedback to a second input of the signal processor;
an amplifier receiving as input an output of said signal processor and driving a hearing aid receiver that generates such internal sound, and
means for selecting between signal processes of the signal processor to provide optimal reproduction of speech or ambient music.

4. The hearing aid according to claim 3, wherein said selecting means comprises one of manual selection or automatic selection

5. The hearing aid according to claim 4, wherein said automatic selection comprises an automatic selection performed by analysis in real time of microphone detected sound, and a determination as to a predominance of one of speech components or music components within such sound.

6. The hearing aid according to claim 4, wherein said automatic selection comprises automatic selection between signal processes of the signal processor providing optimal reproduction of speech or music in accordance with said analyzed predominance of speech or music components, correspondingly;
wherein such selected optimal reproduction of speech is provided by a signal process performed by the signal processor and comprising at least one gain curve and compression algorithm derived through conventional audiometric processes; and
wherein such selected optimal reproduction of ambient music is provided by a signal process performed by the signal processor comprising at least one selected from a group consisting of;
(a) a substantially smoothed gain curve;
(b) less than substantially 20 dB of compression per channel;
(c) a substantially smooth and flat frequency response; and
(d) a single channel of compression, in each case “(a)” and “(b)” applied to a spectrum of lower midrange and bass frequencies between one selected from a group consisting of: (i) 200 and 1,000 Hz; (ii) 200 and 2,000 Hz; (iii) 200 to 4,000 Hz; (iv) 40 and 1,000 Hz; (v) 40 to 2,000 Hz; and (vi) 40 and 4,000 Hz.

7. An improved hearing aid inserted into an ear canal and having a seal that substantially isolates external sound outside the ear canal from internal sound within the ear canal, the hearing aid comprising:
a microphone exposed to the external sound and generating a microphone signal,
a signal processor receiving as input the microphone signal,
an amplifier receiving as input an output of said signal processor and driving a hearing aid receiver that generates such internal sound, and
a selectable frequency vent selectable between at least two Helmholtz resonant frequencies including (a) a high frequency between one of substantially 1,000 to 200 Hz and 500 to 200 Hz in order to minimize the occlusion effect when the hearing aid is not linked to a multimedia sound source, or (b) a low frequency between substantially 200 and 40 Hz in order to optimize music reproduction in the lower midrange and bass frequencies when the hearing aid is linked to a multimedia sound source whether or not such hearing aid simultaneously reproduces microphone generated speech.

8. The hearing aid according to claim 7, wherein the selectable frequency vent comprises a user selected frequency vent (USFV).

9. The hearing aid according to claim 7, wherein the selectable frequency vent comprises an automatically selectable frequency vent (ASFV).

10. The hearing aid according to claim 9, wherein the Helmholtz resonant frequency of said ASFV vent is determined by detecting an active hearing aid link to a multimedia sound source, whether or not the hearing aid simultaneously reproduces microphone generated speech, whereupon such vent is automatically selected for a low Helmholtz resonant frequency to optimize multimedia sound and music reproduction in the lower midrange and bass frequencies, or detecting an absence of such active hearing aid link to a multimedia sound source whereupon such vent is automatically selected for a high Helmholtz resonant frequency to minimize the occlusion effect.

11. The hearing aid according to claim 9, wherein the Helmholtz resonant frequency of said ASFV vent is determined by detecting an active hearing aid link to a multimedia sound source, whether or not the hearing aid simultaneously reproduces microphone generated speech, whereupon such vent is automatically selected for a low Helmholtz resonant frequency to optimize multimedia sound and music reproduction, or detecting an absence of such active hearing aid link to a multimedia sound source whereupon such automatic selection is determined by analysis in real time of speech versus music components in the microphone generated sound, whereby a predominance of speech components results in such vent automatically selected for a high Helmholtz resonant frequency in order to minimize the occlusion effect and whereby a predominance of music components results in such vent automatically selected for a low Helmholtz resonant frequency in order to optimize microphone generated ambient music reproduction.

12. The hearing aid according to claim 9, wherein the Helmholtz resonant frequency of said ASFV vent is determined by determining whether or not the hearing aid is linked to a multimedia sound source, analysis in real time of speech versus music components in the microphone generated sound, whereby a predominance of speech components results in such vent automatically selected for a high Helmholtz resonant frequency to minimize the occlusion effect and whereby a predominance of music components results in such vent automatically selected for a low Helmholtz resonant frequency to optimize microphone generated ambient music reproduction.

13. The hearing aid according to claim 7, wherein the selectable frequency vents are in each case adjustable between at least a low and a high Helmholtz resonant frequency and are comprised of one selected from a group consisting of: (a) an aperture disposed on the hearing aid case; and (b) a cylinder disposed on the hearing aid case and having a cross-sectional area, a cylinder length, a first open end exposed to the interior of the hearing aid case, and a second open end exposed to the outside of the hearing aid case.

14. The hearing aid according to claim 9, wherein-the ASFV vent comprises an aperture having a cross-sectional area that is adjusted by means an electromechanical actuator coupled to one of (a) a movable shroud that blocks adjustable portions of such cross-sectional area, or (b) at least one side of a distortable such aperture whereby such actuator alters the cross-sectional area of such aperture, in both cases “(a)” and “(b)” thereby altering the Helmholtz resonant frequency of the ASFV vent.

15. The hearing aid according to claim 9, wherein the ASFV comprises-a cylinder having a length that is adjusted by means of an electromechanical actuator coupled to one of (a) a movable telescopic section of such cylinder whereby a length of the cylinder may be altered, or (b) a least one side of a distortable such cylinder whereby such actuator alters at least one of the length or cross-sectional area of such cylinder, in both cases “(a)” and “(b)” thereby altering the Helmholtz resonant frequency of the ASFV vent.

16. The hearing aid according to claim 8, wherein the USFV comprises-an aperture having a cross-sectional area that is adjusted by means of a mechanical linkage having a first end coupled to one of (i) a movable shroud that blocks adjustable portions of such cross-sectional area, or (ii) at least one side of a distortable such aperture whereby the linkage alters the cross-sectional area of such aperture, and a second end of the linkage exposed to the outside of the hearing aid case and which is manually adjusted in such a manner as to alter the cross-sectional area and consequently the Helmholtz resonant frequency of such aperture of the USFV vent.

17. The hearing aid according to claim 16, wherein the USFV comprises an aperture having a cross-sectional area that is adjusted by means of an electromechanical mechanism that substitutes the mechanical linkage and is user adjusted by means of an electronic control that may be disposed on at least one of the hearing aid case or a wireless controller, thereby altering the Helmholtz resonant frequency of such aperture of the USFV vent.

18. The hearing aid according to claim 8, wherein the USFV comprises a cylinder having a shape that is altered by means of a mechanical linkage having a first end coupled to one of (i) a movable telescopic section of such cylinder, or (ii) at least one side of a distortable such cylinder, whereby the linkage alters the at least one of the length or cross-sectional area of said cylinder, and a second end of the linkage is exposed to the outside of the hearing aid case and which end is user adjustable.

19. The hearing aid according to claim 8, wherein the USFV comprises a cylinder having a length that is adjusted by means of an electromechanical mechanism that is user adjusted by means of an electronic control that is disposed on at least one of the hearing aid case or a wireless controller, thereby altering the Helmholtz resonant frequency of the USFV vent.

20. A hearing aid inserted into an ear canal, the hearing aid comprising:
a seal that substantially isolates external sound outside the ear canal from internal sound within the ear canal;
a vent having a low Helmholtz resonant frequency below one of substantially 300 Hz, 200 Hz, 150 Hz or 100 Hz and disposed on the hearing aid whereby the external sound may vent to the internal sound below said resonant frequency;
a first microphone exposed to the external sound and generating a first microphone signal;
a second microphone exposed to the internal sound and generating a second microphone signal;
a signal processor receiving as a first input the first microphone signal;
occlusion effect cancellation by means of applying the second microphone signal as phase and amplitude compensated waveform negative feedback to a second input of the signal processor; and
an amplifier receiving as input an output of said signal processor and driving a hearing aid receiver that generates such internal sound.

21. The hearing aid according to claim 20, further comprising:
at least one of (a) electronic introduction of natural resonant peaks in the ear canal that would otherwise occur when the ear canal is open as opposed to occluded by the hearing aid, and (b) electronic compensation for inherent resonant peaks in an output of at least one of the first microphone and the receiver.
